(19) United States
(12) Patent Application Publication
(10) Pub. No.: US 2026/0310374 A1
(43) Pub. Date: Oct. 8, 2026

(54) DECODED DATA ACQUISITION METHOD AND APPARATUS, DEVICE AND STORAGE MEDIUM

(71) Applicant: Beijing Zitiao Network Technology Co., Ltd., Beijing (CN)

(72) Inventors: Wenyao DENG, Beijing (CN); Shoubo LAI, Beijing (CN); Jianping LIU, Beijing (CN)

(21) Appl. No.: 19/481,784

(22) PCT Filed: Jun. 6, 2024
(86) PCT No.: PCT/CN2024/097854

§ 371 Date: Nov. 5, 2025

(30) Foreign Application Priority Data
Jun. 28, 2023 (CN) 202310776768.7

(51) Int. Cl. G06F 3/06; G11B 27/022; G11B 27/10

(52) U.S. Cl. CPC G06F 3/0655; G06F 3/0604; G06F 3/0679; G11B 27/022; G11B 27/102

(57) ABSTRACT

Disclosed in the present disclosure are a decoded data acquisition method and apparatus, a device, and a storage medium, to solve the problem of low overall efficiency of NLE caused by low decoded data acquisition efficiency in the prior art. The method includes: decoding a target image frame in a material track clip, to generate decoded data of the target image frame; storing the decoded data into a multi-level cache space based on a multi-level caching strategy, where the multi-level caching strategy includes: caching the decoded data of the target image frame in a first storage space if decoded data that has been cached in the first storage space does not reach an upper limit of the first storage space, or caching the decoded data of the target image frame in a second storage space if decoded data that has been cached in a first storage space reaches the upper limit of the first storage space; determining a target storage space from the multi-level cache space; and reading the decoded data of the target image frame from the target storage space, rendering the target image frame based on the decoded data, and displaying a preview image.

### CROSS-REFERENCE TO RELATED APPLICATION(S)

The present application claims priority to Chinese Patent Application No. 202310776768.7, filed on Jun. 28, 2023 and entitled “DECODED DATA ACQUISITION METHOD AND APPARATUS, DEVICE AND STORAGE MEDIUM”, which is incorporated herein by reference in its entirety.

### FIELD

The present disclosure relates to the field of computer technologies, and in particular, to a decoded data acquisition method and apparatus, an electronic device, and a computer-readable storage medium.

### BACKGROUND

When a user edits materials such as a video file using a non-linear edit (NLE) system, it is possible to perform a seek operation on a material loaded onto a video editing track.

Performing a seek operation on the material loaded onto the video editing track refers to dragging a timeline on the video editing track, or dragging the material loaded onto the video editing track, so that positions of the timeline and the material change relative to each other along a time axis of the video editing track, then locating a target playback position of the material based on the timeline position, and rendering and presenting at least an image frame in the material located at the target playback position. The material loaded onto the video editing track may be referred to as a material track clip.

According to the prior art, after the seek operation is performed, the NLE system decodes the material currently loaded into a memory in real time based on the located target playback position, to obtain decoded data of the image frame corresponding to the target playback position, and then render and present the image frame based on the decoded data.

The problem with real-time decoding of the video file to obtain the decoded data of the image frame matching the target playback position is that the efficiency of obtaining the decoded data is low, which reduces overall efficiency of the NLE.

### SUMMARY

Embodiments of the present disclosure provide a decoded data acquisition method, to solve the problem in the prior art that in response to a preview operation triggered on a video editing track, real-time decoding of a material is used to obtain decoded data of an image frame matching a target playback position, which results in low decoded data acquisition efficiency and further results in low overall efficiency of NLE.

Embodiments of the present disclosure further provide a decoded data acquisition apparatus, an electronic device, and a computer-readable storage medium.

Embodiments of the present disclosure employ the following technical solutions.

The decoded data acquisition method includes:
decoding a target image frame in a material track clip presented on a video editing track, to generate decoded data of the target image frame;
storing the decoded data of the target image frame into a multi-level cache space based on a multi-level caching strategy, where the multi-level cache space includes at least a first storage space and a second storage space, and a read or write speed of the first storage space is greater than a read or write speed of the second storage space; and the multi-level caching strategy includes: caching the decoded data of the target image frame in the first storage space if decoded data of image frames that has been cached in the first storage space does not reach an upper limit of the first storage space, or caching the decoded data of the target image frame in the second storage space if decoded data of image frames that has been cached in the first storage space reaches the upper limit of the first storage space.
determining, in response to a preview operation triggered on the video editing track, a target storage space from the multi-level cache space if a timeline position of the target image frame in the material track clip is previewed, the target storage space is configured to store the decoded data of the target image frame; and
reading the decoded data of the target image frame from the target storage space, rendering the target image frame based on the decoded data, and displaying a preview image, if the decoded data of the target image frame is stored in the multi-level cache space.

The decoded data acquisition apparatus includes:
a decoding unit, configured to decode a target image frame in a material track clip presented on a video editing track, to generate decoded data of the target image frame;
a storage unit, configured to store the decoded data of the target image frame into a multi-level cache space based on a multi-level caching strategy, where the multi-level cache space includes at least a first storage space and a second storage space, and a read or write speed of the first storage space is greater than a read or write speed of the second storage space; and the multi-level caching strategy includes: caching the decoded data of the target image frame in the first storage space if decoded data of image frames that has been cached in the first storage space does not reach an upper limit of the first storage space, or caching the decoded data of the target image frame in the second storage space if decoded data of image frames that has been cached in the first storage space reaches the upper limit of the first storage space;
a storage space determining unit, configured to determine, in response to a preview operation triggered on the video editing track, a target storage space from the multi-level cache space if a timeline position of the target image frame in the material track clip is previewed, the target storage space is configured to store the decoded data of the target image frame; and
a data acquisition and displaying unit, configured to read the decoded data of the target image frame from the target storage space, render the target image frame based on the decoded data, and display a preview image, if the decoded data of the target image frame is stored in the multi-level cache space.

The electronic device includes: a memory and a processor, where
the memory is configured to store programs; and the processor is coupled to the memory, and is configured to execute the programs stored in the memory to perform the above decoded data acquisition method.

The computer-readable storage medium storing computer programs. The computer programs, when executed by a computer, are capable of implementing the above decoded data acquisition method.

At least one of the above-mentioned technical solutions employed by embodiments of the present disclosure is capable of achieving the following beneficial effects.

Since the multi-level cache space including at least the first storage space and the second storage space is used to store the decoded data generated by decoding the target image frame in the material track clip, in response to the preview operation triggered on the video editing track, in the case of previewing the timeline position of the target image frame in the material track clip, if the decoded data of the target image frame is stored in the multi-level cache space, it is possible to obtain the decoded data of the target image frame from the target storage space of the multi-level cache space, to render the target frame and display the preview image. There is no need to perform real-time decoding of a video file to obtain decoded data of a target image frame as in the prior art. Therefore, the efficiency of obtaining decoded data is improved, and the overall efficiency of NLE is improved.

### BRIEF DESCRIPTION OF THE DRAWINGS

The accompanying drawings illustrated here are used to provide a further understanding of the present disclosure and constitute a part of the present application, and the illustrative embodiments of the present disclosure and the description thereof are used to explain the present disclosure and do not constitute improper limitations on the present disclosure. In the accompanying drawings:

FIG. 1a is a flowchart of a specific implementation of a decoded data acquisition method according to an embodiment of the present disclosure;

FIG. 1b is a schematic diagram of an interface of a non-linear edit system;

FIG. 2 is a schematic diagram of a specific implementation process of a decoded data acquisition method in a non-linear edit system according to an embodiment of the present disclosure;

FIG. 3 is a schematic diagram of a specific implementation process of a decoded data acquisition method in a non-linear edit system according to an embodiment of the present disclosure;

FIG. 4 is a schematic diagram of a specific structure of a decoded data acquisition apparatus according to an embodiment of the present disclosure; and

FIG. 5 is a schematic structural diagram of an electronic device according to an embodiment of the present disclosure.

### DETAILED DESCRIPTION OF EMBODIMENTS

In order to make the objectives, technical solutions and advantages of the present disclosure clearer, the technical solutions of the present disclosure will be clearly and completely described below with reference to specific embodiments of the present disclosure and corresponding accompanying drawings thereof. It is clear that the described embodiments are merely some rather than all of the embodiments of the present disclosure. All other embodiments obtained by those of ordinary skill in the art based on the embodiments of the present disclosure without any creative efforts shall fall within the scope of protection of the present disclosure.

A person of ordinary skill in the art may learn that, with technology development and emergence of a new scenario, the technical solutions provided in embodiments of the present disclosure are also applicable to a similar technical problem.

In the specification, claims, and accompanying drawings of the present disclosure, the terms “first”, “second”, and so on are intended to distinguish between similar objects but do not necessarily indicate a specific order or sequence. It should be understood that the terms used in this way are interchangeable under appropriate circumstances, and this is merely a way of distinguishing between objects with the same properties in the embodiments of the present disclosure. In addition, the terms “include” and “have” and any variants thereof are intended to cover a non-exclusive inclusion. For example, a process, method, system, product, or device that includes a list of units is not necessarily limited to those units, but may include other units not expressly listed or inherent to such a process, method, product, or device.

In order to solve the problem in the prior art that in response to a preview operation triggered on a video editing track, real-time decoding of a material is used to obtain decoded data of an image frame matching a target playback position, which results in low decoded data acquisition efficiency and further results in low overall efficiency of NLE, embodiments of the present disclosure provide a decoded data acquisition method.

An execution subject of the method may be, for example, a computing device such as a cell phone, a personal computer, or a wearable device, or may be software installed on a computing device, such as a player or decoder for video files. Embodiments of the present disclosure do not limit what computing device or software the execution subject is.

In addition, different steps of the method may be implemented by different computing devices or software, and embodiments of the present disclosure do not limit which computing device or software is used to implement which step.

For ease of description, the method provided in the embodiments of the present disclosure is described in detail below by using an example in which the execution body of the method is a non-linear edit system installed on a computing device.

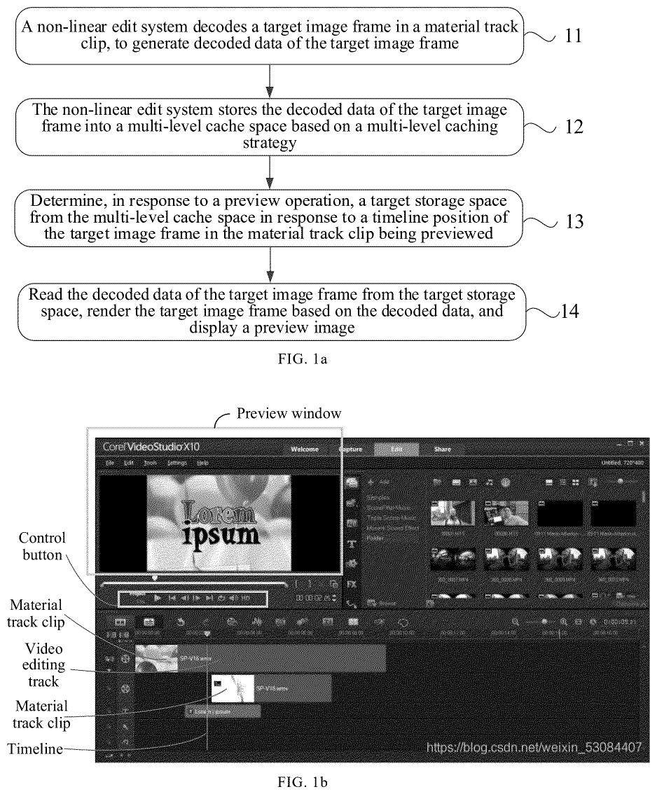

Refer to FIG. 1a in the specification. FIG. 1a is a flowchart of a specific implementation of a decoded data acquisition method according to an embodiment of the present disclosure, including the steps as follows.

At step 11, a non-linear edit system decodes a target image frame in a material track clip presented on a video editing track, to generate decoded data of the target image frame.

For step 11, in an optional implementation, the non-linear edit system may, for example, decode the target image frame contained in the material track clip in response to a preview instruction of a user for the material track clip presented on the video editing track, to generate the decoded data of the target image frame.

In step 11, the “target image frame” may refer not specifically to a specific image frame, but generally to an image in a material track clip to be decoded by a linear edit system.

At step 12, the non-linear edit system stores the decoded data of the target image frame into a multi-level cache space based on a multi-level caching strategy.

The multi-level cache space described here includes at least: a first storage space and a second storage space.

In an embodiment of the present disclosure, a read or write speed of the first storage space is greater than a read or write speed of the second storage space.

In a specific example, the first storage space may be, for example, a dedicated storage space. The second storage space may be, for example, a shared storage space.

The dedicated storage space described here is a storage space that is specifically used to store the decoded data obtained by decoding the target image frame in the material track clip, and is not used to store other data. In contrast, the shared storage space is a storage space that can be used to store the decoded data obtained by decoding the target image frame in the material track clip, and can also be used to store other data.

In an optional implementation, an identifier is set for a storage space to indicate whether the storage space is a dedicated storage space or a shared storage space, so that it can indicate whether the storage space is a dedicated storage space or a shared storage space. When data is to be stored into a dedicated storage space (or a shared storage space), it may be determined, based on the identifier, whether the storage space is a dedicated storage space or a shared storage space, and then it may be further determined whether the data currently to be stored can be stored into the dedicated storage space (or the shared storage space) based on a preset storage rule like “the dedicated storage space is specifically used to store the decoded data obtained by decoding the target image frame in the material track clip, and is not used to store other data; and the shared storage space can be used to store the decoded data obtained by decoding the target image frame in the material track clip, and can also be used to store other data”.

Alternatively, the dedicated storage space refers to a storage space used by a graphics processing unit (GPU) of a computing device itself and not shared with other applications. The shared storage space refers to a storage space that is available to all applications, but the GPU has priority in using the shared storage space.

In a specific example, the first storage space may be, for example, a graphics memory. The second storage space may be, for example, a memory.

In an embodiment of the present disclosure, the multi-level caching strategy may include but is not limited to: caching the decoded data of the target image frame in the first storage space if decoded data of image frames that has been cached in the first storage space does not reach an upper limit of the first storage space; or caching the decoded data of the target image frame in the second storage space if the decoded data of image frames that has been cached in the first storage space reaches the upper limit of the first storage space.

For a specific implementation of step 12, in an optional implementation, the decoded data generated by performing step 11 may first be stored in a local memory of the computing device on which the non-linear edit system is installed, so that the non-linear edit system can obtain the decoded data from the memory, and then store the decoded data into the multi-level cache space. Certainly, when the second storage space is a memory and the decoded data of the image frames that has been stored in the first storage space reaches the upper limit of the first storage space, the non-linear edit system may not perform the operation of obtaining the decoded data from the memory and storing the decoded data into the second storage space.

In an optional implementation, to enable flexible collaborative storage of data, the first storage space may include: a first sub-storage space and a second sub-storage space. In a specific example, when the first storage space is a graphics memory, the first sub-storage space is a dedicated graphics memory and the second sub-storage space is a shared graphics memory.

The dedicated graphics memory refers to a memory used by the GPU of the computing device itself and not shared for use by other applications. The shared graphics memory refers to a memory that all applications can use, but the GPU has priority in using the memory.

In an optional implementation, when the first storage space includes the first sub-storage space and the second sub-storage space, the multi-level caching strategy described in embodiments of the present disclosure may further include: caching the decoded data of the target image frame in the second sub-storage space if decoded data of image frames that has been cached in the first sub-storage space reaches an upper limit of the first sub-storage space.

When the first storage space includes the first sub-storage space and the second sub-storage space, the multi-level cache space in the embodiments of the present disclosure is equivalent to being composed of at least three types of storage spaces. The three types of storage spaces are respectively: the first sub-storage space, the second sub-storage space, and the second storage space. In a specific example, the first sub-storage space, the second sub-storage space, and the second storage space may be respectively: a dedicated graphics memory, a shared graphics memory, and a memory.

In an embodiment of the present disclosure, a specified storage space may be implemented as the multi-level cache space by the non-linear edit system by using the following steps before storing the decoded data into the multi-level cache space.

First, the non-linear edit system obtains a size of a volatile storage space (including a memory and a graphics memory) currently available to the computing device, for example, may obtain the size of the currently available volatile storage space from a global resource center of the computing device, that is, obtains a size of a currently free volatile storage space. The global resource center may be a component of the computing device having a permission to obtain information such as usage of the volatile storage memory.

Then, the non-linear edit system may determine, based on the size of the currently available volatile storage space obtained (such as 100 M memory and 50 M graphics memory) and a preset resource usage proportion (such as 60%), the multi-level cache space, which is 60% of the currently available 100 M memory (that is, 60 M memory) and 60% of the currently available 50 M graphics memory (that is, 30 M graphics memory).

After the multi-level cache space is determined, the decoded data can then be stored into the multi-level cache space for subsequent query. It should be noted that the decoded data stored into the multi-level cache space may be provided with an identifier of the decoded data, such as a frame number of an image frame corresponding to the decoded data. Alternatively, the decoded data may be correspondingly stored into the multi-level cache space together with the frame number of the corresponding image frame for subsequent query.

It should be noted that, in the embodiment of the present disclosure, the purpose of storing the decoded data obtained by decoding the material track clip into the multi-level cache space is primarily as follows: if the non-linear edit system subsequently detects a preview operation for the material track clip that is triggered on the video editing track, when there is decoded data corresponding to an image to be previewed in the multi-level cache space, the decoded data can be obtained directly from the multi-level cache space without decoding the material track clip in real time to obtain the decoded data. This ensures efficient data acquisition in a video editing process.

The embodiments of the present disclosure have the following features for the storage of decoded data:
1. The non-linear edit system stores the decoded data obtained through decoding for the image in the “material track clip presented on the video editing track”, rather than decoded data obtained through decoding for a material that has not yet been loaded on the video editing track.
2. The decoded data stored into the multi-level cache space is decoded data obtained through decoding during video editing, not decoded data obtained through decoding in other processes, nor decoded data obtained by decoding an image not yet previewed during video editing, so that with the decoded data storage manner provided in the embodiment of the present disclosure, the storage of decoded data is naturally performed without intentionally decoding the image in advance to obtain the decoded data, but is accompanied by a preview process of the image.

The above two features are designed to take into account that in the “non-linear edit” scenario, the user is likely to reposition the material track clip for preview at any time, for example, perform a seek operation as described in the background art. In such a scenario and context of need, decoded data that has been obtained through decoding before the seek operation is stored, so that the stored decoded data can be obtained directly for rendering and presenting the preview image when the seek operation occurs, thereby improving non-linear edit efficiency.

At step 13, in response to a preview operation triggered on the video editing track, the non-linear edit system determines a target storage space from the multi-level cache space if a timeline position of the target image frame in the material track clip is previewed.

The preview operation triggered on the video editing track may include, for example, but is not limited to, a seek operation triggered on the video editing track, that is operation of: dragging a timeline on the video editing track, or dragging the material loaded onto the video editing track, so that positions of the timeline and the material change relative to each other along a time axis of the video editing track, then locating a target playback position of the material based on the timeline position, and rendering and presenting at least an image frame in the material located at the target playback position.

Certainly, in addition to the operation of dragging the timeline or dragging the material, another operation that can cause the positions of the timeline and the material to change relative to each other along the time axis of the video editing track, thereby relocating the target playback position of the material based on the timeline position, and rendering and presenting at least the image frame in the material located at the target playback position may fall within the category of “preview operation” as described in embodiments of the present disclosure.

To help readers understand a relationship between the preview operation triggered on the video editing track and the timeline position, FIG. 1b of the specification may be referred. FIG. 1b is a schematic diagram of presenting a material track clip on a video editing track of a non-linear edit system. As shown in the figure, an image frame contained in the material track clip can be previewed in a preview window. Below the playback window there are control buttons that support playback control of video files.

In an actual scenario, a user may directly drag a timeline as shown in FIG. 1b, which is the preview operation described in step 13. Alternatively, the user can long press the “Rewind Play” button in the control buttons, which is also the preview operation described in step 13.

In an actual scenario, the user may perform a preview operation in any manner, and embodiments of the present disclosure do not limit how to perform a preview operation.

For the target image frame described in step 13, as described above, the “target image frame” does not specifically refer to a specific image frame, but generally refers to an image, in a material track clip, that is decoded by a linear edit system. In step 13, if the preview operation causes the timeline position to coincide with a position of an image in the material track clip, in general, the linear edit system sequentially obtains decoded data of the image, decoded data of another image belonging to the same material track clip as the image but arranged after the image, and decoded data of an image located on another video editing track and arranged in another material track clip following the material track clip to which the image belongs, and sequentially obtains preview images of all the images through rendering based on the obtained decoded data.

If, under the trigger of the preview operation, the above-mentioned decoded data to be obtained by the linear edit system contains the decoded data of the target image described in step 11, and the decoded data of the target image exists in the multi-level cache space, the linear edit system may determine the target storage space from the multi-level cache space, and then the subsequent step 14 is performed. If, under the trigger of the preview operation, the above-mentioned decoded data to be obtained by the linear edit system does not contain the decoded data of the target image described in step 11, or the decoded data of the target image described in step 11 is contained, but the decoded data does not exist in the multi-level cache space yet, the linear edit system no longer performs the subsequent step 14, but obtains the decoded data according to a conventional decoded data acquisition method, for example, obtains the image frame from image frames currently loaded onto the memory for decoding to obtain the decoded data.

In an embodiment of the present disclosure, whether the decoded data of the target image exists in the multi-level cache space may be determined by the linear edit system by querying the multi-level cache space based on the identifier of the target image.

In an embodiment of the present disclosure, the identifier of the target image may refer to a number of the target image in the material track clip to which the target image belongs, and may be, for example, a frame number of an image frame.

In an embodiment of the present disclosure, it is assumed that the decoded data of the target image frame has been stored into the multi-level cache space by performing step 12, and currently has not been consumed. In this case, either of the following two situations can trigger the non-linear edit system to determine, from the multi-level cache space, the target storage space where the target image frame is stored: 1. the timeline position just coincides with the position of the target image frame; and 2. the timeline position coincides with a position of an image that is arranged before the target image frame in the material track clip.

The target storage space refers to a storage space for storing the decoded data of the target image frame, and may be the first storage space or the second storage space.

As previously mentioned, in an embodiment of the present disclosure, the multi-level caching strategy is used to store decoded data. Based on the multi-level caching strategy, the decoded data is preferentially stored in the first storage space with a larger read or write speed, and when an upper limit for storage of the first storage space is reached, the decoded data is stored in the second storage space.

It may be understood that from the viewpoint of guaranteeing the efficiency of obtaining the decoded data, if the decoded data can always be read from the first storage space with a larger read or write speed, the efficiency of obtaining the decoded data can be guaranteed to the greatest extent. Therefore, in an embodiment of the present disclosure, decoded data stored in the second storage space are sequentially transferred to free storage locations released in the first storage space based on a first in first out (FIFO) rule, if decoded data stored in the first storage space is consumed.

This data transfer method is used in consideration of the process of previewing the image frame of the material track clip on the video editing track, which conforms to the feature of “previewing sequentially from the timeline position”. Based on this feature, if decoded data of previewed image frames can be moved sequentially from the second storage space to the first storage space in the FIFO manner, theoretically the decoded data can always be read (i.e. consumed) from the first storage space with a larger read or write speed. This ensures the efficiency of obtaining the decoded data and thus the overall efficiency of NLE.

Corresponding to the above-mentioned sequential transfer manner of decoded data, an optional implementation of determining the target storage space from the multi-level cache space in step 13 may include the following sub-steps 1 and 2.

At sub-step 1, the target storage space is queried for the decoded data of the target image frame based on a data query strategy.

At sub-step 2: a storage space where the decoded data of the target image frame found by the querying is determined located as the target storage space.

The data query strategy may include: querying different storage spaces included in the multi-level cache space sequentially in descending order of read or write speeds of the storage spaces.

Based on the data query strategy, if it is found by the querying that the decoded data of the target image frame exists in the multi-level cache space, a specific storage space where the decoded data is located may be determined, that is, the target storage space is determined. Then, step 14 is performed.

At step 14: If the decoded data of the target image frame is stored in the multi-level cache space, the non-linear edit system reads the decoded data of the target image frame from the target storage space, renders the target image frame based on the decoded data of the target image frame, and displays a preview image.

In an optional implementation, when step 12 of storing the decoded data of the target image frame is being performed, an identifier of the target image frame and the decoded data may be correspondingly stored. In this way, in step 14, the decoded data stored corresponding to the identifier of the target image frame can be read from the target storage space based on the identifier as the decoded data of the target image frame.

After the decoded data of the target image frame is read, the target image frame can be rendered based on the decoded data and the preview image can be displayed.

In an optional implementation, the non-linear edit system may read the decoded data in the target storage space into a memory of a graphics processing unit (graphics memory for short), so that the graphics processing unit can perform rendering based on the decoded data to obtain the preview image corresponding to the target image frame.

Decoded data stored in the multi-level cache space may include decoded data that has not been obtained, from the multi-level cache space, and used (which may be referred to as consumed) by the non-linear edit system for a recent period of time. Such decoded data is “cold data”. The cold data constantly occupies storage resources, which is equivalent to wasting storage resources. Therefore, in an optional implementation, the non-linear edit system may clear, based on a data eviction rule that is set based on a least recently used (LRU) algorithm, decoded data that meets the data eviction rule from the multi-level cache space.

The LRU algorithm is to replace the least used data. In an embodiment of the present disclosure, the data eviction rule set based on the LRU algorithm may include: eliminating relatively least used data and replacing the least used data with decoded data that is most recently obtained through decoding.

The above-mentioned eviction method can ensure that the storage resources of the multi-level cache space are fully utilized, avoiding the problem of wasted resources caused by infrequently used “cold data” occupying storage resources.

In an optional implementation, when the non-linear edit system obtains the decoded data for rendering, the non-linear edit system specifically triggers the graphics processing unit to implement the obtaining and rendering. For the graphics processing unit, efficiency of obtaining the decoded data from a graphics memory for rendering is higher than that of obtaining the decoded data from a memory for rendering. This is because if the graphics processing unit obtains the decoded data from the memory of the computing device, the obtained decoded data is read from the memory to the graphics memory and then the decoded data is obtained from the graphics memory for rendering. Therefore, from the perspective of the graphics processing unit, when both the memory and the graphics memory can be used to store decoded data, the decoded data is preferentially stored into the graphics memory, which is more conducive to the graphics processing unit to efficiently obtain the decoded data obtained through decoding.

Based on the above considerations, in an embodiment of the present disclosure, the graphics memory is determined as a storage space with a higher consumption priority in the multi-level cache space, and the memory is determined as a second storage space with a lower consumption priority in the multi-level cache space. The “consumption priority” here may be equivalent to the “read or write speed” previously described, and may specifically refer to a read or write speed in data reading or writing performed by the graphics processing unit.

Further, if the first storage space includes a dedicated graphics memory (i.e. the first sub-storage space) and a shared graphics memory (i.e. the second sub-storage space), the dedicated graphics memory may further be determined as a storage space with the highest consumption priority in the multi-level cache space, and the shared graphics memory is determined as a storage space with the second highest consumption priority in the multi-level cache space.

It should be noted that the consumption priority of the multi-level cache space is equivalent to a query priority that the non-linear edit system follows to query the decoded data stored in the multi-level cache space. A higher consumption priority of a storage space indicates that the storage space is more preferentially queried during query of the non-linear edit system for decoded data.

Based on the different types of storage spaces contained in the multi-level cache space having different consumption priorities, in an optional implementation, the non-linear edit system may query the target storage space for the decoded data of the target image frame based on the data query strategy; and determine a storage space where the decoded data of the target image frame found by the querying is located as the target storage space.

The data query strategy includes: querying different storage spaces included in the multi-level cache space sequentially in descending order of read or write speeds (i.e. consumption priorities) of the storage spaces.

According to the above-mentioned method provided in the embodiments of the present disclosure, since the multi-level cache space including at least the first storage space and the second storage space is used to store the decoded data generated by decoding the target image frame in the material track clip, in response to the preview operation triggered on the video editing track, in the case of previewing the timeline position of the target image frame in the material track clip, if the decoded data of the target image frame is stored in the multi-level cache space, it is possible to obtain the decoded data of the target image frame from the target storage space of the multi-level cache space, to render the target frame and display the preview image. There is no need to perform real-time decoding of a video file to obtain decoded data of a target image frame as in the prior art. Therefore, the efficiency of obtaining decoded data is improved, and the overall efficiency of NLE is improved.

To help readers better understand the method provided in the embodiments of the present disclosure, a specific implementation process of the above described decoded data acquisition method in the non-linear edit system is described below in conjunction with an actual scenario.

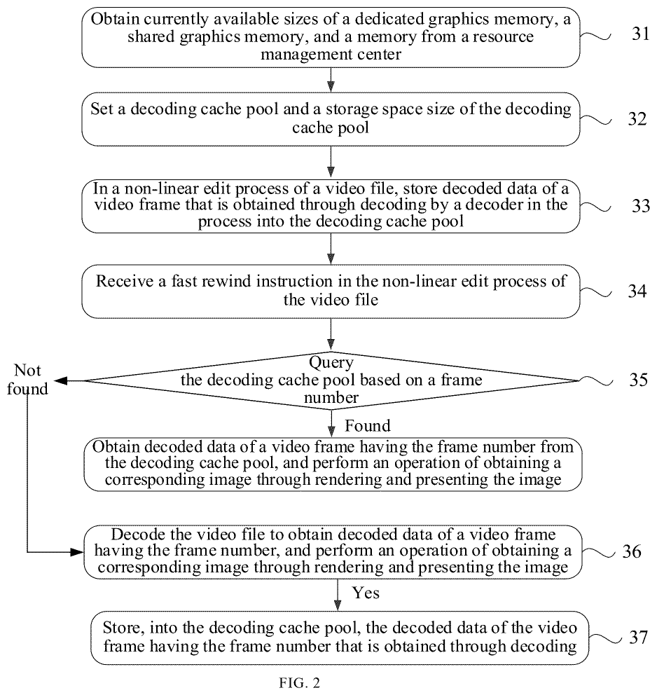

FIG. 2 in the specification is a schematic diagram of a specific implementation process of the decoded data acquisition method in an actual scenario. With reference to FIG. 2, a body performing steps in the process may be, for example, the non-linear edit system. The process mainly includes the following steps.

At step 31, the non-linear edit system obtains currently available sizes of a dedicated graphics memory, a shared graphics memory, and a memory from a global resource center of a local device (such as a personal computer of a user) where the non-linear edit system is installed.

At step 32, the non-linear edit system sets or specifies the dedicated graphics memory, the shared graphics memory, and the memory as a decoding cache pool and collectively sets, based on a default resource usage proportion of 60%, 60% of a currently available memory size of each of the dedicated graphics memory, the shared graphics memory, and the memory to a storage space size of the decoding cache pool.

In an embodiment of the present disclosure, consumption priorities of the dedicated graphics memory, the shared graphics memory, and the memory may be arranged as follows: dedicated graphics memory>shared graphics memory>memory.

At step 33, in a non-linear edit process of a video file, the non-linear edit system stores decoded data of a video frame that is obtained through decoding by a decoder in the process into the decoding cache pool.

During storing of the decoded data of the video frame into the decoding cache pool, the decoded data of the video frame is stored into the decoding cache pool in descending order of consumption priorities based on a rule of filling up different types of storage spaces (including the dedicated graphics memory, the shared graphics memory, and the memory) contained in the decoding cache pool in sequence.

The “filling up” mentioned here refers to, for example, filling up 60% of the currently available storage space size of the dedicated graphics memory, using the above example.

At step 34, the non-linear edit system receives a fast rewind instruction in the non-linear edit process of the video file.

At step 35, the non-linear edit system queries, in response to the instruction, the decoding cache pool based on a frame number of a video frame to be decoded corresponding to the instruction.

If it is found that there is decoded data of a video frame having the frame number in the decoding cache pool, the decoded data of the video frame having the frame number is obtained directly from the decoding cache pool, and then an operation of obtaining a corresponding preview image through rendering and presenting the preview image is performed based on the decoded data of the video frame. The decoded data of the video frame obtained by the non-linear edit system from the decoding cache pool, as the decoded data of the video frame being consumed, is to be deleted from the decoding cache pool, and the decoded data of the video frame stored in the decoding cache pool is then transferred in the FIFO manner. For details, refer to related descriptions in the above embodiment. Details are not described here again.

If the decoded data of the video frame having the frame number is not found in the decoding cache pool, step 36 is performed.

At step 36, the non-linear edit system decodes a video file loaded in a memory of a computing device to obtain decoded data of a video frame having the frame number, and further performs, based on the video frame, an operation of obtaining a corresponding image through rendering and presenting the image. In addition, step 37 is performed.

At step 37, the non-linear edit system stores, into the decoding cache pool, the decoded data of the video frame having the frame number that is obtained through decoding by performing step 36.

It should be noted that the non-linear edit system may run a thread like “Recyle Thread” for monitoring the usage of decoded data of a video frame stored in the decoding cache pool. If the thread detects that a quantity of times decoded data of a specific video frame or specific video frames stored in the decoding cache pool is consumed from a moment when it is stored to a current moment is the smallest compared to decoded data of other video frames, for example, less than a preset threshold (Cache Threshold), the non-linear edit system may clear, based on a data eviction rule determined based on an LRU algorithm, decoded data of a video frame that meets the data eviction rule from the decoding cache pool, for example, eliminate decoded data of a video frame that has been consumed for a quantity of times less than the preset threshold (Cache Threshold).

According to the above-mentioned solution provided in the embodiment of the present disclosure, the decoding cache pool is used to store the decoded data of the video frame obtained through decoding in the process in which the non-linear edit system decodes the video file for presentation. Based on this, decoded data of a specified video frame can be obtained from the decoding cache pool when an instruction of triggering decoding of the video file to obtain the decoded data of the specified video frame is received, unlike the prior art in which it is required to decode a video file in real time to obtain decoded data of a specified video frame. This improves efficiency of obtaining the decoded data of the specified video frame in the process.

For a specific implementation process of the above solution, further reference may be made to the schematic diagram shown in FIG. 3.

Based on the same inventive concept as the previous embodiments, in order to solve the problem in the prior art that in response to a preview operation triggered on a video editing track, real-time decoding of a material is used to obtain decoded data of an image frame matching a target playback position, which results in low decoded data acquisition efficiency and further results in low overall efficiency of NLE, embodiments of the present disclosure further provide a decoded data acquisition apparatus.

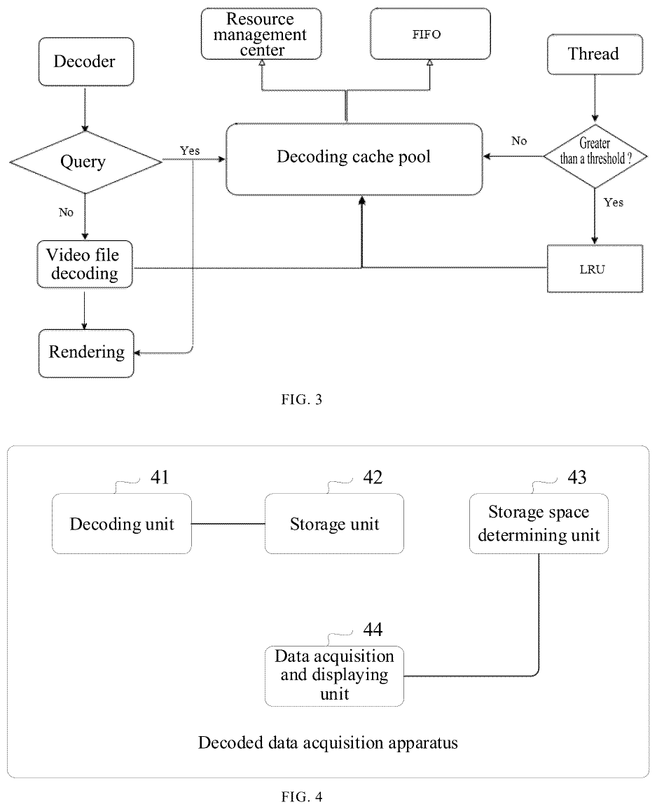

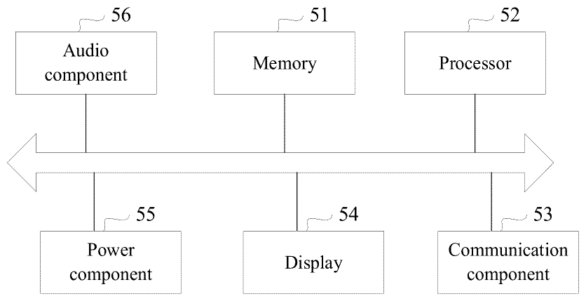

A schematic diagram of a specific structure of the apparatus is shown in FIG. 4. The apparatus includes the following functional units.

A decoding unit 41 is configured to decode a target image frame in a material track clip presented on a video editing track, to generate decoded data of the target image frame.

A storage unit 42 is configured to store the decoded data of the target image frame into a multi-level cache space based on a multi-level caching strategy. The multi-level cache space includes at least a first storage space and a second storage space, and a read or write speed of the first storage space is greater than a read or write speed of the second storage space. The multi-level caching strategy includes: caching the decoded data of the target image frame in the first storage space if decoded data of image frames that has been cached in the first storage space does not reach an upper limit of the first storage space, or caching the decoded data of the target image frame in the second storage space if decoded data of image frames that has been cached in the first storage space reaches the upper limit of the first storage space.

A storage space determining unit 43 is configured to determine, in response to a preview operation triggered on the video editing track, a target storage space from the multi-level cache space if a timeline position of the target image frame in the material track clip is previewed. The target storage space is configured to store the decoded data of the target image frame.

A data acquisition and displaying unit 44 is configured to read the decoded data of the target image frame from the target storage space, render the target image frame based on the decoded data, and display a preview image, if the decoded data of the target image frame is stored in the multi-level cache space.

In an optional implementation, the storage space determining unit 43 may be configured to: query the target storage space for the decoded data of the target image frame based on a data query strategy; and determine a storage space where the decoded data of the target image frame found by the querying is located as the target storage space.

The data query strategy includes: querying different storage spaces included in the multi-level cache space sequentially in descending order of read or write speeds of the storage spaces.

In an optional implementation, the apparatus provided in the embodiment of the present disclosure may further include: a data transfer unit, configured to transfer decoded data stored in the second storage space sequentially to free storage locations released in the first storage space based on a first in first out FIFO rule, if decoded data stored in the first storage space is consumed.

In an optional implementation, the first storage space is a dedicated storage space; and the second storage space is a shared storage space. Alternatively, the first storage space is a graphics memory; and the second storage space is a memory.

In an optional implementation, the first storage space includes: a first sub-storage space and a second sub-storage space. When the first storage space is a graphics memory, the first sub-storage space is a dedicated graphics memory, and the second sub-storage space is a shared graphics memory.

The multi-level caching strategy further includes: caching the decoded data of the target image frame in the second sub-storage space if decoded data of image frames that has been cached in the first sub-storage space reaches an upper limit of the first sub-storage space.

In an optional implementation, the apparatus provided in the embodiment of the present disclosure may further include: a data clearing unit, configured to clear, based on a data eviction rule that is set based on a least recently used LRU algorithm, decoded data that meets the data eviction rule from the multi-level cache space.

According to the above-mentioned decoded data acquisition apparatus provided in the embodiments of the present disclosure, since the multi-level cache space including at least the first storage space and the second storage space is used to store the decoded data generated by decoding the target image frame in the material track clip, in response to the preview operation triggered on the video editing track, in the case of previewing the timeline position of the target image frame in the material track clip, if the decoded data of the target image frame is stored in the multi-level cache space, it is possible to obtain the decoded data of the target image frame from the target storage space of the multi-level cache space, to render the target frame and display the preview image. There is no need to perform real-time decoding of a video file to obtain decoded data of a target image frame as in the prior art. Therefore, the efficiency of obtaining decoded data is improved, and the overall efficiency of NLE is improved.

Based on the same inventive concept as the previous embodiments, embodiments of the present disclosure further provide an electronic device, in order to solve the problem in the prior art that in response to a preview operation triggered on a video editing track, real-time decoding of a material is used to obtain decoded data of an image frame matching a target playback position, which results in low decoded data acquisition efficiency and further results in low overall efficiency of NLE.

As shown in FIG. 5, the electronic device includes: a memory 51 and a processor 52. The memory 51 may be configured to store various other data to support operation on the electronic device. Examples of such data include instructions for any application or method used for operation on the electronic device. The memory 51 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The processor 52 is coupled to the memory 51 to execute a program stored in the memory 51, so as to perform the decoded data acquisition method described in the embodiments of the present disclosure, or perform the multimedia data storage method described in the embodiments of the present disclosure.

The processor 52 may implement other functions in addition to the above functions when executing the program in the memory 51. For details, refer to the descriptions in the above embodiments.

Further, as shown in FIG. 5, the electronic device may further include: a display 54, a communication component 53, a power component 55, an audio component 56, and other components. Only some of the components are shown schematically in FIG. 5, and this does not mean that the electronic device includes only the components shown in FIG. 5.

Accordingly, embodiments of the present disclosure further provide a computer-readable storage medium storing computer programs which, when executed by a computer, is capable of implementing the steps or functions of the methods provided in the above embodiments.

The apparatus embodiment described above is merely schematic, where the units described as separated components may or may not be physically separated, and the components displayed as units may or may not be physical units, that is, may be located at one position or may be distributed to a plurality of network units. Some or all of the modules may be selected based on actual needs to achieve the objectives of the solutions of the embodiments, which can be understood and implemented by those of ordinary skill in the art without involving any inventive effort.

According to the foregoing descriptions of the implementations, a person skilled in the art may clearly understand that the foregoing implementations may be implemented by using software plus a required universal hardware platform, or certainly may be implemented by using hardware. Based on such an understanding, the above technical solutions essentially or the part contributing to the current technology may be implemented in a form of a software product. The computer software product may be stored in a computer-readable storage medium, such as a ROM or RAM, a hard disk, or an optical disc, and includes several instructions for instructing a computer device (which may be a personal computer, a server, or a network device) to perform the methods described in embodiments or some parts of embodiments of the present invention.

It should be finally noted that the above embodiments are merely for describing rather than limiting the technical solutions of the present disclosure. Although the present disclosure has been illustrated in detail with reference to the foregoing embodiments, it should be understood by those of ordinary skill in the art that modifications may still be made to the technical solutions described in the foregoing embodiments, or equivalent replacements may be made to a part of the technical features; and these modifications or replacements will not cause the essence of corresponding technical solutions to depart from the spirit and scope of the technical solutions in the embodiments of the present disclosure.

1. A decoded data acquisition method, comprising:
decoding a target image frame in a material track clip presented on a video editing track, to generate decoded data of the target image frame;
storing the decoded data of the target image frame into a multi-level cache space based on a multi-level caching strategy, wherein the multi-level cache space comprises at least a first storage space and a second storage space, and a read or write speed of the first storage space is greater than a read or write speed of the second storage space; and the multi-level caching strategy comprises: caching the decoded data of the target image frame in the first storage space in response to decoded data of image frames having been cached in the first storage space not reaching an upper limit of the first storage space, or caching the decoded data of the target image frame in the second storage space in response to decoded data of image frames having been cached in the first storage space reaching the upper limit of the first storage space;
determining, in response to a preview operation triggered on the video editing track, a target storage space from the multi-level cache space in response to a timeline position of the target image frame in the material track clip being previewed, the target storage space being configured to store the decoded data of the target image frame; and
reading the decoded data of the target image frame from the target storage space, rendering the target image frame based on the decoded data, and displaying a preview image, in response to the decoded data of the target image frame being stored in the multi-level cache space.

2. The method according to claim 1, wherein determining the target storage space from the multi-level cache space comprises:
querying the target storage space for the decoded data of the target image frame based on a data query strategy; and
determining a storage space where the decoded data of the target image frame found by the querying is located as the target storage space, the data query strategy comprising: querying different storage spaces comprised in the multi-level cache space sequentially in descending order of read or write speeds of the storage spaces.

3. The method according to claim 2, further comprising:
transferring decoded data stored in the second storage space sequentially to free storage locations released in the first storage space based on a first in first out FIFO rule, in response to decoded data stored in the first storage space being consumed.

4. The method according to claim 1, wherein the first storage space is a dedicated storage space; and the second storage space is a shared storage space; or
the first storage space is a graphics memory; and the second storage space is a memory.

5. The method according to claim wherein the first storage space comprises: a first sub-storage space and a second sub-storage space;
in response to the first storage space being a graphics memory, the first sub-storage space is a dedicated graphics memory, and the second sub-storage space is a shared graphics memory; and
the multi-level caching strategy further comprises: caching the decoded data of the target image frame in the second sub-storage space in response to decoded data of image frames having been cached in the first sub-storage space reaching an upper limit of the first sub-storage space.

6. The method according to claim 1, further comprising:
clearing, based on a data eviction rule that is set based on a least recently used LRU algorithm, decoded data that meets the data eviction rule from the multi-level cache space.

7. (canceled)

8. (canceled)

9. (canceled)

10. (canceled)

11. (canceled)

12. (canceled)

13. An electronic device, comprising: a memory and a processor, wherein
the memory is configured to store programs; and
the processor is coupled to the memory, and the programs-stored when being executed, configure the processor to:
decode a target image frame in a material track clip presented on a video editing track, to generate decoded data of the target image frame;
store the decoded data of the target image frame into a multi-level cache space based on a multi-level caching strategy, wherein the multi-level cache space comprises at least a first storage space and a second storage space, and a read or write speed of the first storage space is greater than a read or write speed of the second storage space; and the multi-level caching strategy comprises: caching the decoded data of the target image frame in the first storage space in response to decoded data of image frames having been cached in the first storage space not reaching an upper limit of the first storage space, or caching the decoded data of the target image frame in the second storage space in response to decoded data of image frames having been cached in the first storage space reaching the upper limit of the first storage space;
determine, in response to a preview operation triggered on the video editing track, a target storage space from the multi-level cache space in response to a timeline position of the target image frame in the material track clip being previewed, the target storage space being configured to store the decoded data of the target image frame; and
read the decoded data of the target image frame from the target storage space, render the target image frame based on the decoded data, and display a preview image, in response to the decoded data of the target image frame being stored in the multi-level cache space.

14. A non-transitory computer-readable storage medium storing computer programs which, when executed by a computer, decoded configure the computer to:
decode a target image frame in a material track clip presented on a video editing track, to generate decoded data of the target image frame;
store the decoded data of the target image frame into a multi-level cache space based on a multi-level caching strategy, wherein the multi-level cache space comprises at least a first storage space and a second storage space, and a read or write speed of the first storage space is greater than a read or write speed of the second storage space; and the multi-level caching strategy comprises: caching the decoded data of the target image frame in the first storage space in response to decoded data of image frames having been cached in the first storage space not reaching an upper limit of the first storage space, or caching the decoded data of the target image frame in the second storage space in response to decoded data of image frames having been cached in the first storage space reaching the upper limit of the first storage space;
determine, in response to a preview operation triggered on the video editing track, a target storage space from the multi-level cache space in response to a timeline position of the target image frame in the material track clip being previewed, the target storage space being configured to store the decoded data of the target image frame; and
read the decoded data of the target image frame from the target storage space, render the target image frame based on the decoded data, and display a preview image, in response to the decoded data of the target image frame being stored in the multi-level cache space.

15. The electronic device according to claim 13, wherein the programs to configure the processor to determine the target storage space from the multi-level cache space comprise programs to configure the processor to:
query the target storage space for the decoded data of the target image frame based on a data query strategy; and
determine a storage space where the decoded data of the target image frame found by the querying is located as the target storage space, the data query strategy comprising: querying different storage spaces comprised in the multi-level cache space sequentially in descending order of read or write speeds of the storage spaces.

16. The electronic device according to claim 15, wherein the programs further comprise programs to configure the processor to:
transfer decoded data stored in the second storage space sequentially to free storage locations released in the first storage space based on a first in first out FIFO rule, in response to decoded data stored in the first storage space being consumed.

17. The electronic device according to claim 13, wherein the first storage space is a dedicated storage space; and the second storage space is a shared storage space; or the first storage space is a graphics memory; and the second storage space is a memory.

18. The electronic device according to claim 13, wherein the first storage space comprises: a first sub-storage space and a second sub-storage space;
in response to the first storage space being a graphics memory, the first sub-storage space is a dedicated graphics memory, and the second sub-storage space is a shared graphics memory.

19. The electronic device according to claim 18, wherein the multi-level caching strategy further comprises: caching the decoded data of the target image frame in the second sub-storage space in response to decoded data of image frames having been cached in the first sub-storage space reaching an upper limit of the first sub-storage space.

20. The electronic device according to claim 13, the programs further comprise programs to configure the processor to:
clear, based on a data eviction rule that is set based on a least recently used LRU algorithm, decoded data that meets the data eviction rule from the multi-level cache space.

21. The non-transitory computer-readable storage medium according to claim 14, wherein the computer programs to configure the computer to determine the target storage space from the multi-level cache space comprise computer programs to configure the computer to:
query the target storage space for the decoded data of the target image frame based on a data query strategy; and
determine a storage space where the decoded data of the target image frame found by the querying is located as the target storage space, the data query strategy comprising: querying different storage spaces comprised in the multi-level cache space sequentially in descending order of read or write speeds of the storage spaces.

22. The non-transitory computer-readable storage medium according to claim 21, wherein the computer programs further comprise computer programs to configure the computer to:
transfer decoded data stored in the second storage space sequentially to free storage locations released in the first storage space based on a first in first out FIFO rule, in response to decoded data stored in the first storage space being consumed.

23. The non-transitory computer-readable storage medium according to claim 14, wherein the first storage space is a dedicated storage space; and the second storage space is a shared storage space; or the first storage space is a graphics memory; and the second storage space is a memory.

24. The non-transitory computer-readable storage medium according to claim 14, wherein the first storage space comprises: a first sub-storage space and a second sub-storage space;
in response to the first storage space being a graphics memory, the first sub-storage space is a dedicated graphics memory, and the second sub-storage space is a shared graphics memory.

25. The non-transitory computer-readable storage medium according to claim 24, wherein the multi-level caching strategy further comprises: caching the decoded data of the target image frame in the second sub-storage space in response to decoded data of image frames having been cached in the first sub-storage space reaching an upper limit of the first sub-storage space.

26. The non-transitory computer-readable storage medium according to claim 14, the computer programs further comprise computer programs to configure the computer to:
clear, based on a data eviction rule that is set based on a least recently used LRU algorithm, decoded data that meets the data eviction rule from the multi-level cache space.
